(19) United States
(12) Patent Application Publication
(10) Pub. No.: US 2020/0312121 A1
(43) Pub. Date: Oct. 1, 2020

(54) ALARM SYSTEM SUPERVISORY BY ZONE

(71) Applicant: Personal and Recreational Products, Inc., Westlake, TX (US)

(72) Inventor: Timothy A. Shiner, Westlake, TX (US)

(21) Appl. No.: 16/366,808

(22) Filed: Mar. 27, 2019

(51) Int. Cl. G08B 26/00; G08B 29/14

(52) U.S. Cl. CPC G08B 26/003; G08B 29/14; G08B 26/007; G08B 26/008

(57) ABSTRACT

A premises alarm system includes multiple alarm sensors and a control panel. Each alarm sensor is configured to send a status signal. The control panel includes a processor, a wireless transceiver, and a storage medium. The storage medium stores instructions for execution by the processor. The processor can receive an assignment of the alarm sensors to different ones of multiple supervisory zones. The processor can receive a specified polling rate for each of the supervisory zones. The specified polling rate of one supervisory zone is different from the specified polling rate of another supervisory zone. The processor monitors for the status signal from each of the alarm sensors. The processor causes an alarm signal in response to determining that a status signal was not received from any one of the alarm sensors at the specified polling rate for the assigned supervisory zone.

### BACKGROUND

A premises alarm system, often referred to as a security system, is designed to sound an audible alarm and/or contact a remote facility, such as a central monitoring station or municipal emergency services (e.g., police, fire and/or medical services), in response to specified conditions. For example, the premises alarm system can monitor for opening of doors of a building or house, opening or breakage of windows, monitor for a presence of a person within rooms of the building or house, monitor for the presence of fire or smoke on the premises, and monitor for other conditions. Then, the system can sound an audible alarm and contact either directly, or via the central monitoring station, emergency services (e.g., the police upon detection of an unauthorized person on the premises or fire services upon detection of a fire at the premises).

### SUMMARY

Certain aspects of the subject matter described can be implemented as a premises alarm system. The premises alarm system includes multiple alarm sensors and a control panel. Each alarm sensor is configured to send a status signal. The control panel includes a processor, a wireless transceiver interoperably coupled to the processor, and a non-transitory computer-readable storage medium interoperably coupled to the processor. The storage medium stores instructions for execution by the processor. The instructions instruct the processor to perform operations. The operations include receiving an assignment of the multiple alarm sensors to different ones of multiple supervisory zones. The operations include receiving a specified polling rate for each of the supervisory zones. The specified polling rate of one supervisory zone is different from the specified polling rate of another supervisory zone. The operations include monitoring, via the wireless transceiver, for the status signal from each of the multiple alarm sensors. The operations include causing a specified response in response to determining that a status signal was not received from any one of the multiple alarm sensors at the specified polling rate for the assigned supervisory zone.

This, and other aspects, can include one or more of the following features.

The operations can include causing the wireless transceiver to periodically transmit a status request to each of the alarm sensors at the specified polling rate assigned to the respective supervisory zone.

The alarm sensors can include a motion sensor, a door sensor, a window sensor, or a combination of these.

At least one of the alarm sensors can be attached to any one of a person, a pet, a firearm, a painting, a jewelry box, a safe, or a vehicle.

The operations can include causing an alarm signal in response to receiving a signal from any one of the alarm sensors indicating that the alarm sensor has been actuated.

The supervisory zones can include at least 4 and at most 300 supervisory zones.

Each of the polling rates can be between once per second and once per 70 minutes.

The control panel can be configured to be programmable to set the supervisory zones and the corresponding polling rates by a program on a device remotely connected to the control panel.

The specified response can include an alarm signal.

Certain aspects of the subject matter described can be implemented as a method. An assignment of multiple alarm sensors to different ones of multiple supervisory zones is received. A specified polling rate for each of the supervisory zones is received. Each of the alarm sensors are monitored for a status signal. A specified response is triggered in response to determining that the status signal was not received from any one of the alarm sensors at the specified polling rate for the assigned supervisory zone.

This, and other aspects, can include one or more of the following features.

A status request can be periodically transmitted to each of the alarm sensors at the specified polling rate assigned to the respective supervisory zone.

Each of the polling rates can be between once per second and once per 70 minutes.

An alarm can be triggered in response to receiving a signal from any one of the alarm sensors indicating that the alarm sensor has been actuated.

The specified response can include an alarm signal.

Certain aspects of the subject matter described can be implemented as an alarm control panel. The alarm control panel includes a processor, a wireless transceiver interoperably coupled to the processor, and a non-transitory computer-readable storage medium interoperably coupled to the processor. The storage medium stores instructions for execution by the processor. The instructions instruct the processor to perform operations. The operations include receiving an assignment of multiple alarm sensors to different ones of multiple supervisory zones. The operations include receiving a specified polling rate for each of the supervisory zones. The specified polling rate of one supervisory zone is different from the specified polling rate of another supervisory zone. The operations include monitoring, via the wireless transceiver, for the status signal from each of the multiple alarm sensors. The operations include causing a specified response in response to determining that a status signal was not received from any one of the multiple alarm sensors at the specified polling rate for the assigned supervisory zone.

This, and other aspects, can include one or more of the following features.

The operations can include causing the wireless transceiver to periodically transmit a status request to each of the alarm sensors at the specified polling rate assigned to the respective supervisory zone.

The operations can include causing an alarm signal in response to receiving a signal from any one of the alarm sensors indicating that the alarm sensor has been actuated.

The supervisory zones can include at least 4 and at most 300 supervisory zones.

Each of the polling rates can be between once per second and once per 70 minutes.

The control panel can be configured to be programmable to set the supervisory zones and the corresponding polling rates by a program on a device remotely connected to the control panel.

### DESCRIPTION OF DRAWINGS

FIGS. 1A & 1B are a schematic diagrams of example alarm systems.

FIG. 2 is a schematic diagram of an example alarm panel.

FIG. 3 is a flow chart of an example method that can, for example, be implemented by the example alarm system shown in FIG. 1A.

Like reference symbols in the various drawings indicate like elements.

### DETAILED DESCRIPTION

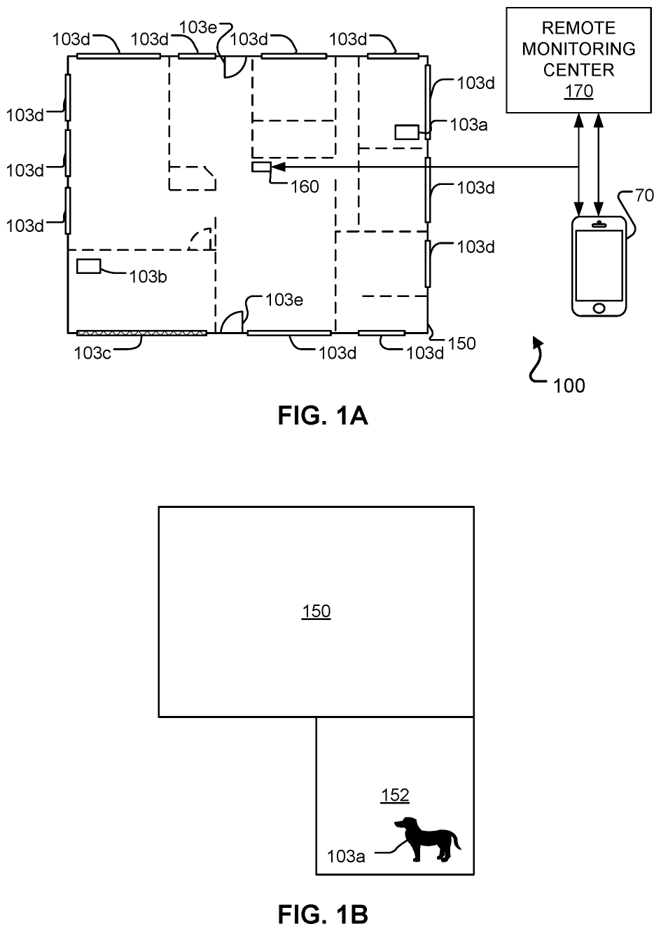

FIG. 1A schematically illustrates a premises alarm system 100 installed on a premises 150, such as a home or business. The premises alarm system 100 includes a control panel 160 and is of the type configured to sound an audible alarm at the premises and/or contact a facility remote from the premises, such as a central monitoring station or municipal emergency services (e.g., police, fire and/or medical services), in response to specified conditions. For example, the premises alarm system 100 can monitor for opening of doors of a building or house, opening or breakage windows of the building or house, monitor for a presence of a person within rooms of the building or house, monitor for the presence of fire or smoke on the premises, and/or monitor for and alarm on occurrence of other specified conditions. Then, the system 100 can respond in a specified manner, including any one or combination of sounding an audible alarm at the premises and contacting either directly, or via the central monitoring station, emergency services (e.g., the police upon detection of an unauthorized person on the premises or fire services upon detection of a fire at the premises) and/or contacting a user of the alarm system 100 via a telephone call, SMS, via an application on the user's personal smart device (e.g., smart phone, computer, tablet, wearable or other smart devices), or in another manner.

The illustrated panel 160 can be a standalone panel, having the needed processor/memory (an in some instances, one or more of the sensors) and software to operate an alarm system (such as alarm system 100). In other instances, the alarm system 100 can be a distributed system having components distributed around the premises 150, for example, having an alarm box with some components (e.g., processor/memory and/or other components) of the alarm system 100 that is separate from the panel 160. In some instances, the premises alarm system 100 may be of a type that is permanently or semi-permanently installed at a residence or business, or can be a freestanding, portable alarm system. The alarm system 100 can be programmed (for example, setting up the various zones, receiving an assignment of a sensor to a zone and logically assigning the sensor to the zone, receiving a specified polling rate for a zone and logically assigning the polling rate to the zone, or receiving a specified response and logically assigning the response to a zone and triggering event) at the control panel 160. In some implementations, the alarm system 100 can be programmed through a program or application installed, for example, on a computer or handheld device (such as a cell phone). The alarm system 100 can be programmed by a user (for example, a homeowner or business owner), a security supervisor (for example, an alarm company tasked with overseeing security of a premises or object), or a remote monitoring center 170. In some implementations, the alarm system 100 is programmed with default settings when manufactured.

In some implementations, the alarm system 100 is configured to communicate with the user, offsite to the monitoring center 170 and/or municipal emergency services via a telephone network, such as a Public Switched Telephone Network (PSTN), Internet Protocol (IP) network or another telephone network. The control panel 160 includes one or more wireless transceivers for communicating wirelessly with other wireless components of the alarm system 100, such as sensors, home automation devices, as well as offsite and with user's mobile devices. In certain instances, the transceivers communicate per Institute of Electrical and Electronics Engineers (IEEE) 802.11 (e.g., Wi-Fi), IEEE 802.15.4 (e.g., Bluetooth and Zigbee), Z-Wave (an 800-900 MHz protocol promulgated by Silicon Laboratories, Inc., on frequencies of 319 MHz), 345 MHz, 319 MHz, 900 MHz, cellular (e.g., voice, SMS, and data protocols), and/or in other frequencies and protocols. In certain instances, the alarm system 100 can also communicate with other components of the alarm system 100 via wired connections.

The premises alarm system 100 can include one or more user alarm control panels, either physical panels at the premises or soft user interfaces (e.g., web pages or applications), that allow the user to operate the alarm system 100. The interface panels can include buttons for entering a code preset by the user for identifying an authorized user of the system and to arm/disarm the system. In some implementations, the premises alarm system 100 can be configured to be armed in a number of configurations, including some where fewer than all of the available sensors are armed. For example, the premises alarm system 100 is typically configured to be armed in an away mode and a stay mode, where the away mode arms a certain set of available sensors (typically all) and the stay mode leaves certain sensors unarmed to allow a person to reside within a building or house on the premises without triggering an alarm. The alarm control panel can be provided with away and stay shortcut buttons for arming the alarm system 100 to an away mode or a stay mode.

In addition to the typical garage door 103c, window 103d, door 103e, motion, fire, and other alarm sensors, the premises alarm system 100 can also support various wireless presence sensors 103a and 103b designed to trigger a specified response by the alarm system 100 if the sensor leaves the premises. The alarm sensors are distributed throughout the premises 150, for example, in rooms of the premises 150. The presence sensors 103a are of a type that may not have a triggered and set state, like a window sensor 103d or door sensor 103e, but rather the presence sensors 103a and 103b operate simply by sending a status signal to verify the sensor is still active and able to communicate with the alarm system 100. In certain instances, the status signal from the presence sensor (103a or 103b) is sent in response to an inquiry (for example, a status request) by the alarm system 100. In other instances, the status signal from the presence sensor (103a or 103b) is sent at a specified pre-set or adjustable rate (e.g., once per minute, once every 5 minutes, once every 10 minutes, once every 15 minutes and/or at other rates). The rates at which the presence sensors 103a and 103b send status signals can be the same or different from each other. For example, the presence sensors 103a and 103b can optionally be assigned to the same supervisory zone with the same specified pre-set or adjustable rate. As another example, the presence sensors 103a and 103b can optionally be assigned to different supervisory zones with different specified pre-set or adjustable rates. In some implementations, one or more of the presence sensors 103a or 103b can include or be attached to another type of sensor, such as a motion sensor.

Such presence sensors 103a and 103b can be attached to an object that is meant to be kept within the premises 150. In certain instances, an alarm system user might choose to affix the sensor to an object of value, like a painting, antique, or jewelry, or to a pet or person (e.g., a person with impaired mental abilities), to a firearm, or to another object. Although shown in FIG. 1A as having two presence sensors (103a and 103b), the alarm system 100 can include fewer or more presence sensors. When the alarm system 100 detects that a presence sensor (103a or 103b) has left the premises 150, i.e., has become inactive (not sending status signals or unresponsive to status requests), the alarm system 100 can respond in a specified manner, including any one or combination of sounding an audible alarm, contacting either directly, or via the remote monitoring center 170, emergency services (e.g., the police) and/or contacting a user of the alarm system 100 via a telephone call, SMS, via an application on the user's personal smart device (e.g., phone 70, computer, tablet, wearable or other smart devices) or in another manner.

The premises alarm system 100 includes multiple hardwired or logical circuits, referred to as “zones,” that can be individually programmed with parameters relating to the characteristics of the sensor or sensors on the zone, the behavior of the alarm system 100 in monitoring sensors on the zone, and the specified responses when a sensor on the zone is triggered. For example, the alarm system 100 might be configured with all exterior doors on a common zone so that, when the alarm system 100 is set to stay mode, opening a door provides a user time to disable the alarm system 100 before signaling an alarm. In another example, the alarm system 100 might be configured with all exterior windows on a common zone so that, regardless of whether the alarm system 100 is set to stay or away mode, opening a window signals an alarm.

One or more of the zones can be set up as a “supervisory” zone where the premises alarm system 100 monitors and, at a specified rate, periodically confirms that it has received a check-in status signal from the sensors to ensure the sensors are active in the alarm system 100. In certain instances, the alarm system 100 can be configured to send status request signals to the sensors to elicit a status signal. If a sensor is not active, for example, because it is out of wireless range (e.g., has left the premises 150), or has otherwise failed or been disabled, it will not send the check-in status signal. The zone supporting the sensor can be set with a specified response when the alarm system 100 determines it has not received the status signal. In certain instances, depending on the sensor type, the sensor will also send a signal when it is triggered, and the zone supporting the sensor can be set with a specified response (which may be different from the response to an inactive sensor) when the alarm system 100 determines the sensor has been triggered. For example, a wireless door or window sensor would have both a triggered state and be configured to send a check-in status signal.

In certain instances, the alarm system 100 can include two zones, three zones, four zones, or more than four zones (for example, about 100 zones, about 200 zones, or 300 zones). Different zones of the alarm system 100 can be set to different parameters, including supervisory or not supervisory, and for supervisory zones, different supervisory polling rates (i.e., the frequency at which the alarm system 100 confirms that it has received a check-in signal from the sensor(s) on the zone, and if so configured, the frequency at which the alarm system 100 sends a status request and subsequently confirms that it received the check-in signal). In certain instances, the polling rate can be short, such as less than a minute (e.g., 1 second, 10 seconds, or 30 seconds), every few minutes (e.g., 1 minute, 5 minutes, or 10 minutes), or it can be a longer polling period (e.g., every 70 minutes). The polling rate assigned to a supervisory zone can be independently programmable from other zones of the alarm system 100. By putting different sensors, e.g., presence sensors (103a and 103b) and/or other sensors that send status signals (e.g., wireless sensors provided as sensors 103c-103e), on different zones, the polling rate for different sensors can be independently adjustable. The alarm system 100 monitors each of the sensors (e.g., 103a, 103b, 103c, 103d, and 103e) by their zone. If the system 100 does not receive a status signal from a sensor at the specified polling rate assigned to its supervisory zone, the system 100 produces the specified response (e.g., sends an alarm signal and/or another response discussed below). In some implementations, the system 100 sends a status request to each of the sensors at their respective polling rate assigned to their supervisory zone. In such implementations, if the system 100 does not receive a status signal from a sensor in response to the status request, the alarm system 100 can produce the specified response (e.g., send an alarm signal and/or another response discussed below).

In FIG. 1A, the alarm system 100 can be configured with each of the presence sensors 103a and 103b on a different zone and the system 100 configured to poll each of the sensors 103a at corresponding polling rates. In some implementations, the alarm system 100 is configured to poll the sensors 103a and 103b at the same frequency (for example, once every 10 minutes). In some implementations, the alarm system 100 is configured to poll one or more of the sensors 103a and 103b at different frequencies (for example, polling one of the sensors 103a once per hour and another one of the sensors 103b once every ten minutes). Any sensors 103c-103e that send status signals can also be configured on zones configured as supervisory, with one or more of the sensors 103c-103e on different zones which is also different from the zones supporting the presence sensors 103a.

The polling rate at which the alarm system 100 polls each of the sensors (such as presence sensors 103a and 103b) can be adjusted based on the type of sensor, the zone within which the sensor is located, a combination of both, or based on other criteria. For example, if presence sensor 103a is affixed to an object, such that it is important to know quickly when it has left the premises (e.g., a gun, a child, a pet, a mentally infirm person, or a motorcycle) in comparison to other objects, then the alarm system 100 can be configured to poll the zone supporting sensor 103a at a higher frequency in comparison to the zones supporting other sensors. As another example, if sensor 103b is in an area of the premises that is less secure (or perhaps easier to access) than the other areas of the premises, then the alarm system 100 can be configured to poll the zone supporting sensor 103b at a higher frequency in comparison to the other zones. In any example, for other zones of the alarm system 100, the zones can be programmed with a much lower polling rate, for example, to support sensors that do not need to be monitored for their leaving of the premises (e.g., a door sensor 103e or window sensor 103d).

The alarm system 100 is configurable to respond in different manners based on the received signal (or lack thereof, for example, in the case of expecting a status signal from a presence sensor 103a or 103b). For example, the alarm system 100 can be configured to, in response to detecting opening of a garage door (via garage door sensor 103c), notify the remote monitoring center 170 and/or the homeowner (for example, via phone 70), indicating the nature of the triggering event, but not sound an alarm. For example, the alarm system 100 can be configured to, in response to detecting opening of a door (via door sensor 103e), sound a warning to enter the disarming code on the alarm panel, notify the remote monitoring center 170 and/or the homeowner (for example, via phone 70), or any combination of these. The alarm system 100 can be configured to send an alarm signal, sounding an audible alarm on the premises, notify the remote monitoring center 170 and/or the homeowner (for example, via phone 70), call emergency services (such as police), or any combination of these, if the disarming code is not entered on the alarm panel within a certain time limit (for example, one minute) after detecting opening of the door. In some implementations, the alarm system 100 can be configured to cancel an alarm if an alarm cancel code is entered on the alarm panel (for example, stop transmission of an alarm signal or transmit a “false alarm” signal). Notifications can be any type of push notification. For example, the notification can be in the form of an SMS or a pop up notification through an application running on the phone 70.

As another example, the alarm system 100 can be configured to, in response to receiving a movement or an alarm signal from any of the sensors, notify the remote monitoring center 170 and/or the owner (for example, via phone 70). The alarm system 100 can be configured to detect that a person or object (to which a presence sensor 103a or 103b is affixed) is not within the premises 150 based on not receiving an expected status signal from the premise sensor 103a or 103b. The alarm system 100 can be configured to, in response to detecting that the person or object is not within the premises 150, notify the remote monitoring center 170 and/or the owner (for example, via phone 70, call emergency services (such as police), or any combination of these.

FIG. 1B illustrates a schematic view of a premises 150 and a backyard 152 of the premises 150. Although not shown, the alarm system 100 can monitor the premises 150 and the backyard 152 (along with objects and/or persons in either of the locations). A presence sensor (103a or 103b) may be attached to an object that does not normally move frequently (for example, a gun lock locking a gun). A presence sensor (103a or 103b) may be attached to an object that moves frequently. For example, the sensor 103a can be attached to a collar of a pet, which can move freely within the backyard 152. Because the sensor 103a is attached to an object that moves frequently, a user might choose for the alarm system 100 to poll the sensor 103a at a higher frequency in comparison to other sensors (for example, sensors that are not expected to move locations as often). For example, the alarm system 100 can be configured to poll the sensor 103a once every five minutes. In some implementations, the alarm system 100 can be configured to poll a sensor (for example, sensor 103a) at varying frequencies throughout a single day. For example, if the pet (wearing the collar upon which the sensor 103a is attached) is left free to roam the backyard 152 throughout the day but brought inside the premises 150 at night, then the alarm system 100 can be configured to poll the sensor 103a more frequently during the day in comparison to the night.

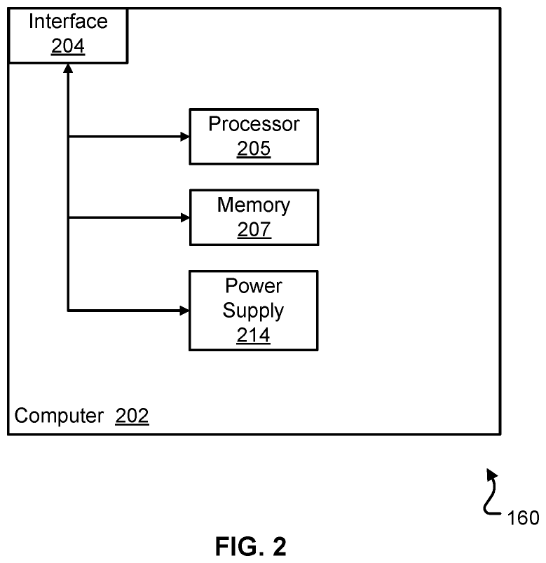

FIG. 2 is a block diagram of an example alarm panel 160. The illustrated alarm panel 160 is a standalone panel, having the needed hardware and software to operate an alarm system (such as alarm system 100a or 100b). In other instances, the alarm system can be a distributed system having components distributed around the premises, for example, having an alarm box with some components of the alarm system that is separate from the alarm panel 160. The system can include a computer 202, which is intended to encompass any computing device such as a dedicated printed circuit board or a desktop/laptop/notebook computer, one or more processors within these devices, or any other suitable processing device, including physical or virtual instances (or both) of the computing device. Additionally, the computer 202 can include an input device, such as a keypad, keyboard, touch screen, or other device that can accept user input, and an output device that conveys information associated with the operation of the computer 202, including digital data, visual, audio information, or a combination of information. In certain instances, the input and output devices of the computer can be embedded in the panel 160.

The alarm system can be programmed (for example, setting the various zones, assigning a sensor to a zone, setting a polling rate for a zone, or setting a response to a triggering event) at the alarm panel 160. In some implementations, the alarm system can be programmed through a program or application installed, for example, on a computer or handheld device (such as a cell phone). The alarm system can be programmed by a user (for example, a homeowner), a security supervisor (for example, an alarm company tasked with overseeing security of a premise or object), or a central monitoring station. In some implementations, the alarm system is programmed with factory settings when manufactured.

The computer 202 includes an input/output interface 204, such as a wired interface or transceiver. Although illustrated as a single interface 204 in FIG. 2, two or more interfaces 204 may be used according to particular implementations of the computer 202. The computer 202 can be communicably coupled with a network via the interface 204. In addition to communicating with sensors and other components of the alarm system, the interface 204 is used by the computer 202 for communicating with other systems that are connected to the network in a distributed environment. The interface 204 may comprise software supporting one or more communication protocols associated with communications such that the network or interface's hardware is operable to communicate physical signals within and outside of the illustrated computer 202.

The computer 202 includes a processor 205. Although illustrated as a single processor 205 in FIG. 2, the processor 205 can be two or more processors. Generally, the processor 205 executes instructions and manipulates data to perform the operations of the computer 202 and any algorithms, methods, functions, processes, flows, and procedures as described in this specification.

The computer 202 also includes a memory 207 that can hold data for the computer 202 or other components (or a combination of both) that can be connected to the network. Although illustrated as a single memory 207 in FIG. 2, the memory 207 can be two or more memory devices 207 (of the same or combination of types) can be used according to particular needs, desires, or particular implementations of the computer 202 and the described functionality. While memory 207 is illustrated as an integral component of the computer 202, memory 207 can be external to the computer 202. The memory 207 can be a transitory or non-transitory storage medium.

The memory 207 stores computer-readable instructions executable by the processor 205 that, when executed, cause the processor 205 to perform the operations described herein. The computer 202 can also include a power supply 214.

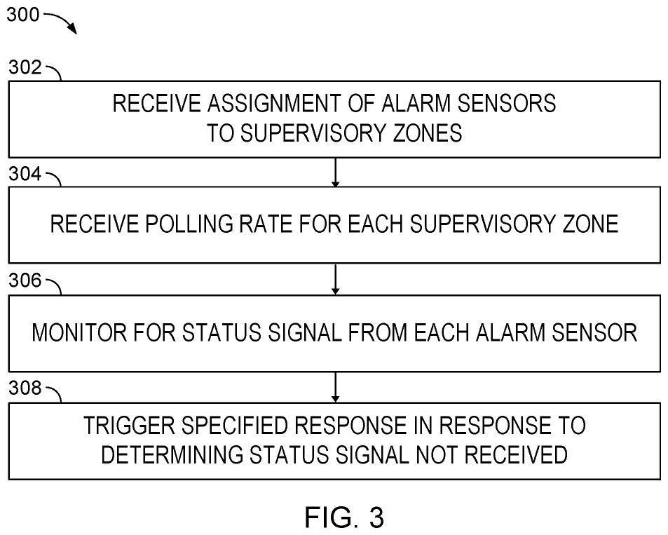

FIG. 3 is a flow chart for a method 300. The method 300 can be implemented by the alarm system 100. For example, method 300 can be implemented using the control panel 160. At step 302, an assignment of multiple alarm sensors (for example, presence sensors 103a) to different ones of multiple supervisory zones are received (for example, by the control panel 160). For example, presence sensor 103a can be assigned to a first supervisory zone with a first specified pre-set or adjustable polling rate, and presence sensor 103b can be assigned to a second supervisory zone with a second specified pre-set or adjustable polling rate. As another example, multiple alarm sensors (such as presence sensors 103a and 103b) can optionally be assigned to the same supervisory zone. The assignment can be received by the control panel 160. In some implementations, the assignment can be sent to the control panel 160 by a program on a device that is remotely connected to the control panel (for example, the phone 70).

At step 304, a specified polling rate for each of the supervisory zones is received. The specified polling rates can be, for example, between once per second and once per 70 minutes. The polling rates of each of the supervisory zones can be adjustable. In some implementations, the specified polling rate is determined based on a pre-set or adjustable rate at which the respective alarm sensor is configured to send a status signal.

At step 306, each of the alarm sensors are monitored for a status signal. In some implementations, the monitoring at step 306 is passive. For example, each of the alarm sensors have a pre-set or adjustable rate at which the respective alarm sensor is configured to send a status signal, and the control panel 160 waits for an expected status signal from each of the alarm sensors. In some implementations, the monitoring at step 306 is active. For example, a status request is periodically transmitted by the control panel 160 to each of the alarm sensors at the specified polling rate assigned to the respective supervisory zone, and then the control panel 160 listens for a status signal in response to the status request. For example, if presence sensor 103a was assigned to the first supervisory zone with a specified polling rate of once per 30 minutes and presence sensor 103b was assigned to the second supervisory zone with a specified polling rate of once per 60 minutes at step 302, then the control panel 160 can transmit a status request to presence sensor 103a once every 30 minutes and to presence sensor 103b once every 60 minutes.

At step 308, a specified response is triggered in response to determining that the status signal was not received from any one of the alarm sensors at the specified polling rate for the assigned supervisory zone. The specified response can be triggered by the control panel 160. For example, if presence sensor 103a was assigned to the first supervisory zone with a specified polling rate of once per 30 minutes at step 302, and a status signal was not received at step 306 by the control panel 160 over a time span of 30 minutes (the specified polling rate), then the control panel 160 triggers the specified response at step 308. In some implementations, the specified response includes an alarm signal. In some implementations, an alarm is triggered in response to receiving a signal from any one of the alarm sensors indicating that the alarm sensor has been actuated. For example, in the case of a motion sensor, the control panel can trigger an alarm in response to receiving a movement signal from the motion sensor. For example, in the case of the window sensor 103d, the control panel can trigger an alarm in response to receiving a window opening signal from the window sensor 103d. The alarm signal can include, for example, an audible alarm, a visual alarm, a notification to the remote monitoring center 170, a notification to the owner (for example, via phone 70), an automated call to emergency services (such as police), or any combination of these.

Particular implementations of the subject matter have been described. Nevertheless, it will be understood that various modifications, substitutions, and alterations may be made without departing from the spirit and scope of this disclosure. Accordingly, the previously described implementations do not define or constrain this disclosure, and other implementations are within the scope of the following claims.

What is claimed is:

1. A premises alarm system, comprising:
a plurality of alarm sensors, wherein each alarm sensor is configured to send a status signal; and
a control panel comprising:
a processor;
a wireless transceiver interoperably coupled to the processor; and
a non-transitory computer-readable storage medium interoperably coupled to the processor and storing instructions for execution by the processor, the instructions instructing the processor to perform operations comprising:
receive an assignment of the plurality of alarm sensors to different ones of a plurality of supervisory zones;
receive a specified polling rate for each of the supervisory zones, wherein the specified polling rate of one supervisory zone is different from the specified polling rate of another supervisory zone;
monitor, via the wireless transceiver, for the status signal from each of the plurality of alarm sensors; and
cause specified response in response to determining that a status signal was not received from any one of the plurality of alarm sensors at the specified polling rate for the assigned supervisory zone.

2. The premises alarm system of claim 1, wherein the operations comprise causing the wireless transceiver to periodically transmit a status request to each of the alarm sensors at the specified polling rate assigned to the respective supervisory zone.

3. The premises alarm system of claim 1, wherein the plurality of alarm sensors comprises a motion sensor, a door sensor, a window sensor, or a combination thereof.

4. The premises alarm system of claim 1, wherein at least one of the alarm sensors is attached to any one of a person, a pet, a firearm, a painting, a jewelry box, a safe, or a vehicle.

5. The premises alarm system of claim 1, wherein the operations comprises causing an alarm signal in response to receiving a signal from any one of the alarm sensors indicating that the alarm sensor has been actuated.

6. The premises alarm system of claim 1, wherein the plurality of supervisory zones comprises at least 4 and at most 300 supervisory zones.

7. The premises alarm system of claim 1, wherein each of the polling rates are between once per second and once per 70 minutes.

8. The premises alarm system of claim 1, wherein the control panel is configured to be programmable to set the supervisory zones and the corresponding polling rates by a program on a device remotely connected to the control panel.

9. The premises alarm system of claim 1, wherein the specified response comprises an alarm signal.

10. A method, comprising:
receiving an assignment of a plurality of alarm sensors to different ones of a plurality of supervisory zones;
receiving a specified polling rate for each of the supervisory zones;
monitoring for a status signal from each of the alarm sensors; and
triggering a specified response in response to determining that the status signal was not received from any one of the alarm sensors at the specified polling rate for the assigned supervisory zone.

11. The method of claim 10, comprising periodically transmitting a status request to each of the alarm sensors at the specified polling rate assigned to the respective supervisory zone.

12. The method of claim 11, wherein each of the specified polling rates are between once per second and once per 70 minutes.

13. The method of claim 10, comprising triggering an alarm in response to receiving a signal from any one of the alarm sensors indicating that the alarm sensor has been actuated.

14. The method of claim 10, where the specified response comprises an alarm signal.

15. An alarm control panel, comprising:
a processor;
a wireless transceiver interoperably coupled to the processor; and
a non-transitory computer-readable storage medium interoperably coupled to the processor and storing instructions for execution by the processor, the instructions instructing the processor to perform operations comprising:
receive an assignment of a plurality of alarm sensors to different ones of a plurality of supervisory zones;
receive a specified polling rate for each of the supervisory zones, wherein the specified polling rate of one supervisory zone is different from the specified polling rate of another supervisory zone;
monitor, via the wireless transceiver, for a status signal from each of the plurality of alarm sensors; and
cause specified response in response to determining that a status signal was not received from any one of the plurality of alarm sensors at the specified polling rate for the assigned supervisory zone.

16. The alarm control panel of claim 15, wherein the operations comprise causing the wireless transceiver to periodically transmit a status request to each of the alarm sensors at the specified polling rate assigned to the respective supervisory zone.

17. The alarm control panel of claim 15, wherein the operations comprises causing an alarm signal in response to receiving a signal from any one of the alarm sensors indicating that the alarm sensor has been actuated.

18. The alarm control panel of claim 15, wherein the plurality of supervisory zones comprises at least 4 and at most 300 supervisory zones.

19. The alarm control panel of claim 15, wherein each of the polling rates are between once per second and once per 70 minutes.

20. The alarm control panel of claim 15, wherein the control panel is configured to be programmable to set the supervisory zones and the corresponding polling rates by a program on a device remotely connected to the control panel.
